(19) United States
(12) Patent Application Publication
(10) Pub. No.: US 2023/0264052 A1
(43) Pub. Date: Aug. 24, 2023

(54) OPENABLE MASK

(71) Applicant: FUNDICOOP CO., LTD., Seoul (KR)

(72) Inventor: Jinwon PARK, Goyang-si (KR)

(21) Appl. No.: 17/904,795

(22) PCT Filed: Nov. 9, 2021
(86) PCT No.: PCT/KR2021/016255

§ 371 Date: Aug. 23, 2022

(30) Foreign Application Priority Data
Nov. 11, 2020 (KR) 10-2020-0149924

(51) Int. Cl. A62B 18/08; A41D 13/11

(52) U.S. Cl. CPC A62B 18/086; A41D 13/1107; A41D 2500/30

(57) ABSTRACT

The present invention relates to a mask provided with a cover that is easily opened or closed when a user drinks or eats, and relates to a mask including a body made of a transparent material and a cover formed integrally with the body and capable of preventing interference with the body, when the cover is opened or closed, by a through-hole formed at an upper portion of the cover.

### TECHNICAL FIELD

The present invention relates to an openable mask provided with a cover that can be opened or closed smoothly when a user drinks or eats.

### BACKGROUND ART

In recent years, various types of pathogenic viruses that are newly generated every year have posed a great threat to the health and survival of humans. In particular, in recent years, following severe acute respiratory syndrome (SARS) and Middle East respiratory syndrome (MERS), new viruses such as coronaviruses have developed a rapid transmission power and set the whole world in panic, and the numbers of confirmed cases and group infections are still increasing. There is still no suitable treatment for the coronavirus, and even when development of a medicine or vaccine is completed, since clinical trials should be undergone, humans may still suffer for a considerable period of time. Thus, quarantine rules so far have focused on prevention to avoid infection with the coronavirus, and in addition to personal hygiene management such as hand washing, users should wear masks to protect themselves from infection.

Further, the coronavirus, which has spread since the beginning of 2020, together with influenza that spreads every winter, is giving people more fear. During unavoidable outdoor activities, people perform routine wearing of masks in addition to step-by-step distancing and personal hygiene management. However, despite the routine wearing of masks, in facilities such as restaurants, cafes, and cafeterias of government offices and companies, large numbers of people frequently talk and eat while sitting face to face at tables.

No matter how much attention people pay to social distancing and personal hygiene management, contact between large numbers of people within a certain distance is unavoidable at specific times such as lunch time at a restaurant or cafeteria as described above. As a result, there is an inevitable increase in risk of group infection at restaurants and cafeterias.

In restaurants and cafeterias in which large numbers of people gather at specific times, in order to avoid droplets secreted from nearby unspecified people or people eating together from entering the human body through the respiratory system of a user, the user should wear a mask even while eating.

However, a general mask has a problem in that, whenever the user eats or drinks, the mask should be taken off or lowered. Thus, in a face-worn covering implement of Japanese Patent Application Publication No. 2007-020983 (hereinafter referred to as related art 1), an adhesive part that may be repeatedly attached or detached is applied, and thus detachment is possible when the user drinks or eats. However, related art 1 has a disadvantage in that, whenever the user drinks or eats, a part of a covering implement (= the mask) should be detached from the adhesive part.

In order to solve this problem of related art 1, Japanese Patent Registration No. 5421507 (hereinafter referred to as related art 2) proposes a mask in which, when a mouth is exposed, a wearer Y lifts a lower portion 30a of cotton of the mask upward (toward the nose), and thus the mouth is exposed. However, this mouth exposure structure corresponds to merely one commonly used method for a user to drink or eat while wearing a disposable mask.

Korean Utility Model No. 446476 (hereinafter referred to as related art 3) has been proposed as a related art related to a mask that allows a user to drink or eat. Related art 3 includes a mask body that is made of an elastic material and has an opening in a center thereof such that a nose and a mouth of a wearer are integrally inserted into the opening and a front cover that covers the nose and mouth inserted into the opening and has an upper portion partially sewn to be open to the lower side. Related art 3 has an advantage in that, by adopting the front cover having the partially sewn upper portion in the mask body, the user can communicate smoothly or drink or eat while wearing the mask. However, related art 3 has a limitation in that, the front cover can be partially sewn only when the mask body is made of an elastic material.

Korean Utility Model Publication No. 2011-0003053 (hereinafter referred to as related art 4) is similar to related art 3 in that a front cover covering the mouth and nose is adopted. That is, in the mask of related art 4, a U-shaped vent 4 having an open upper portion that exposes the mouth and nose is formed in a mask member 2, and a coupling unit 7 such as Velcro or a snap fastener to which a front cover 6 covering the mouth and nose corresponds in a male-female manner is formed in front of the opened U-shaped vent 4. However, in related art 4, there is still inconvenience in that the coupling unit 7 should be separated whenever the user drinks or eats.

### RELATED ART DOCUMENT

### Patent Document

(Patent Document 1) Japanese Patent Application Publication No. 2007-020983, Face-worn covering implement
(Patent Document 2) Japanese Patent Registration No. 5421507, Mask
(Patent Document 3) Korean Utility Model No. 446476, Cold protection mask
(Patent Document 4) Korean Utility Model Publication No. 2011-0003053, Mask

### DISCLOSURE

### Technical Problem

The problems to be solved by the present invention are as follows.

The present invention is directed to providing a mask that allows a wearer to drink a beverage or eat food, wherein the wearer can eat food placed on a table while the food is safely protected from droplets that may be transmitted from many unspecified people, and further, the risk of transmission of the droplets through public restaurants or cafeterias used by many unspecified general people is reduced.

There is a problem in that communication becomes unclear when a wearer talks while wearing a mask that covers their mouth, but even when the wearer wears this mask, a counterpart may see the shape of the mouth of the wearer, and thus communication is smoother.

Manufacturing cost can be reduced by simplifying a structure of a body and a cover.

### Technical Solution

One aspect of the present invention provides an openable mask including a body having an opening through which a mouth of a wearer is exposed and a hanging string on an outer side thereof, and a cover folded to open or close the opening of the body according to the wearer’s selection, wherein the body and the cover are integrally formed and are then formed to be folded with respect to each other at a foldable portion, and a through-hole is provided above the cover along the foldable portion.

The body and the cover of the present invention may be made of a transparent resin material.

The openable mask of the present invention may further include a coupling boss of the body protruding from a lower portion of a front surface of the body, and a coupling hole formed in the cover to face a location at which the coupling boss is formed.

The openable mask of the present invention may further include a female or male Velcro tape formed on a lower portion of a front surface of the body, and a male or female Velcro tape formed on a rear surface of the cover formed to face a location at which the female or male Velcro tape is formed.

The openable mask of the present invention may further include a nose support portion protruding from an upper portion of a rear surface of the body, and a chin support portion protruding from a lower portion of the rear surface of the body.

The openable mask of the present invention may further include an upper nonwoven fabric and a lower nonwoven fabric coupled to a rear surface of the body, wherein the upper nonwoven fabric is located above the nose support portion, and the lower nonwoven fabric is located below the chin support portion.

### Advantageous Effects

An openable mask according to the present invention has the following advantages.

A body and a cover are made of a transparent resin material, and thus durability is excellent.

Since the body and the cover are made of the transparent resin material, a counterpart can see the shape of the mouth of a wearer even in a state in which the wearer wears the mask, and thus clear communication can be performed.

When the cover is opened or closed by a through-hole formed at an upper portion of the cover, interference between the body and the cover is prevented, and thus the cover can be smoothly opened or closed.

Since the body and the cover may be integrally formed by one process, a manufacturing method is simple and economical.

When the wearer does not drink or eat, a state in which the cover is closed is stably maintained by fixing units such as a coupling boss and a coupling hole or Velcro tapes.

### DESCRIPTION OF DRAWINGS

FIG. 1 is a perspective view of a face-worn covering implement of related art 1.

FIG. 2 is a diagram of a usage state of a mask of related art 2.

FIG. 3 is a perspective view of a cold protection mask of related art 3.

FIG. 4 is an exploded perspective view of a mask of related art 4.

FIG. 5 is a front perspective view of an openable mask of the present invention.

FIG. 6 is a rear perspective view of the openable mask of the present invention.

FIG. 7 is a front perspective view illustrating a state in which a cover of the openable mask of the present invention is opened.

FIG. 8 is a front perspective view of an openable mask according to another embodiment of the present invention.

FIG. 9 is a rear perspective view of the openable mask according to another embodiment of the present invention.

FIG. 10 is a front perspective view illustrating a state in which a cover of the openable mask according to another embodiment of the present invention is opened.

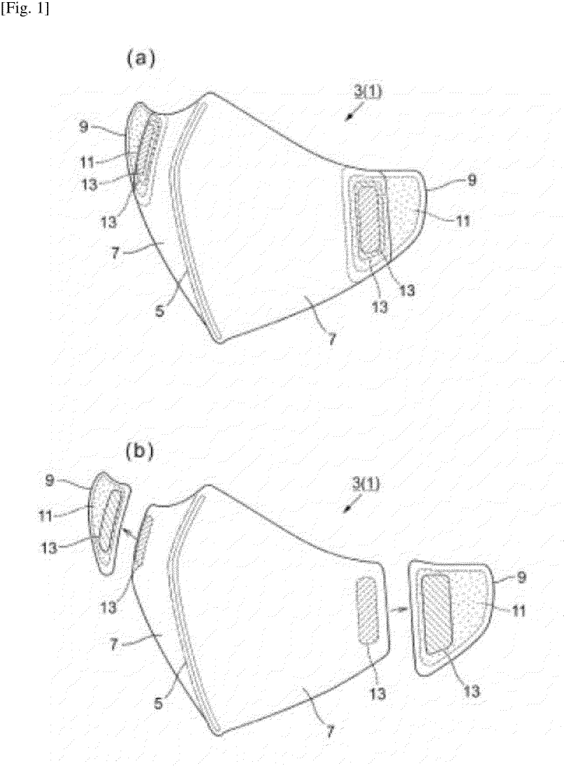

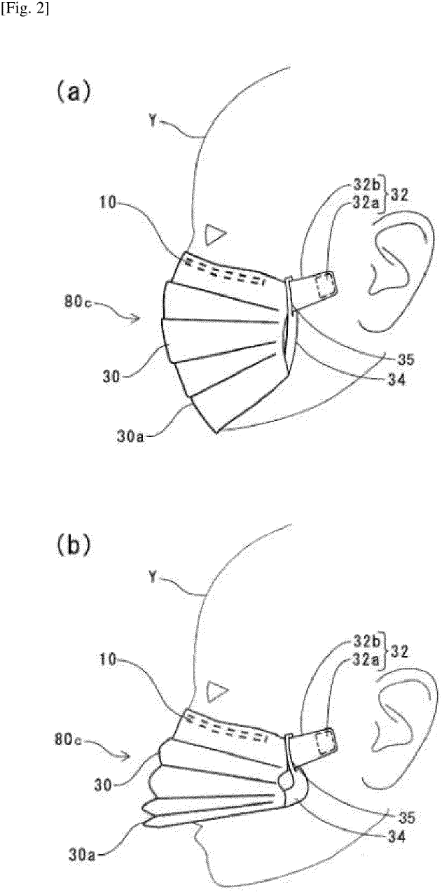

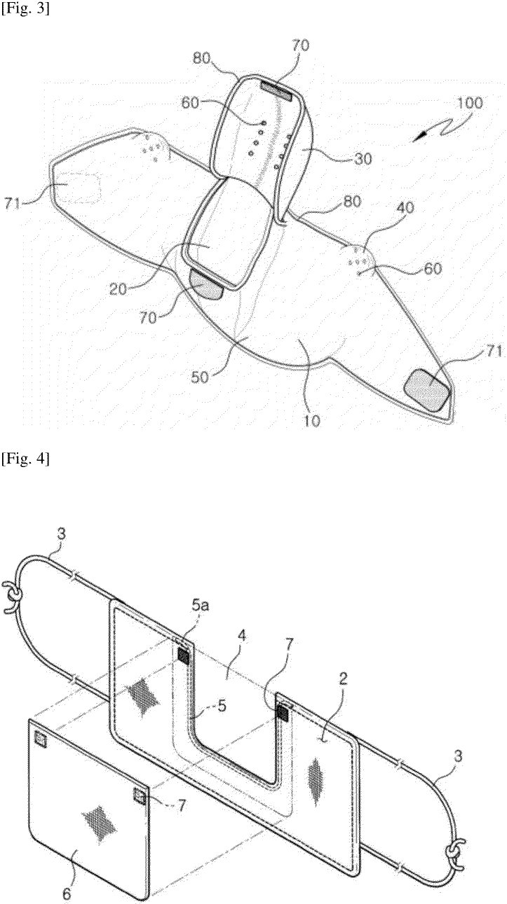

### MODES OF THE INVENTION

The present invention may be modified with various changes and may have various embodiments, and specific embodiments will be described in detail with the accompanying drawings. However, it should be understood that the present invention is not limited to the specific embodiments and includes all changes, equivalents, and substitutions included in the spirit and scope of the present invention.

Terms used in the present application are used only to describe the specific embodiments and are not intended to limit the present invention. Singular expressions include plural expressions unless clearly otherwise indicated in the context. It should be understood in the present application that terms such as “include” or “have” are intended to indicate that features, numbers, steps, operations, components, parts, or combinations thereof described in the specification are present and do not exclude in advance the possibility of the presence or addition of one or more other features, numbers, steps, operations, components, parts, or combinations thereof.

Hereinafter, an openable mask according to exemplary embodiments of the present invention will be described in more detail with reference to the accompanying drawings.

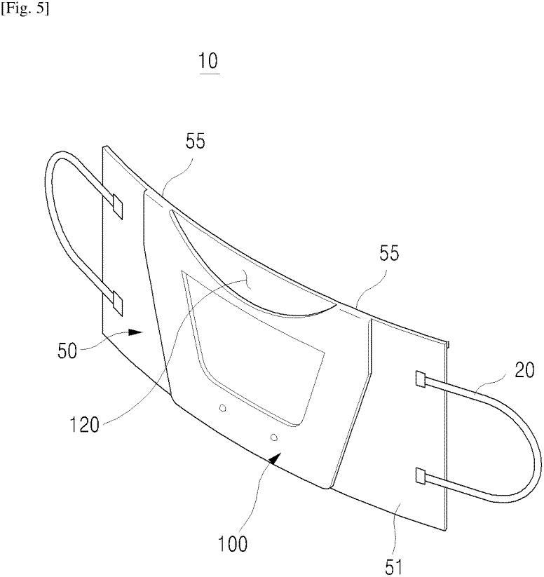

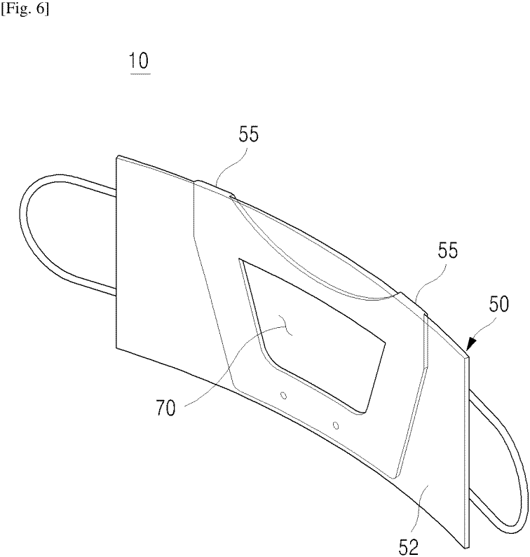

FIGS. 5 to 7 illustrate an openable mask 10 according to the present invention.

The openable mask 10 of the present invention roughly includes a body 50 and a cover 100. First, the body 50 is a general configuration for covering the mouth and nose of a wearer.

In an embodiment of the present invention, the body 50 is made of a transparent resin (plastic) material.

In the embodiment of the present invention, an opening 70 through which the mouth of the wearer is exposed is formed in the body 50.

In the embodiment of the present invention, the opening 70 has a shape in which an upper portion is wide and a lower portion is narrow, but the present invention is not limited thereto as long as the mouth of the wearer is exposed.

A hanging string 20 is formed outside the body 50. The hanging string 20 is hung on an ear of the wearer so that body 50 may be fixed to the face of the wearer.

In the embodiment of the present invention, the cover 100 that is folded to open or close the opening 70 of the body 50 according to the wearer’s selection is provided. Like the body 50, the cover 100 is also made of a transparent resin (plastic) material. The cover 100 may be formed to be larger than the size of the opening 70 formed in the body 50. When the openable mask 10 of the present invention is viewed from the front side, similar to the shape of the opening 70, the cover 100 also has a shape in which an upper portion is wide and a lower portion of narrow. The cover 100 is folded to be able to open or close the opening 70 of the body 50 according to the wearer’s selection.

In the present invention, there is no need to adopt a separate configuration such as a hinge so that the cover 100 may be folded with respect to the body 50. Instead, in the openable mask 10 of the present invention, the cover 100 and the body 50 are integrally formed, and the cover 100 is folded with respect to the body 50, particularly, the opening 70 of the body 50, due to elasticity of the transparent resin material.

In detail, the body 50 and the cover 100 are integrally formed by a method of punching a single fabric. For reference, a foldable portion that is a portion in which the cover 100 and the body 50 are connected is defined as a cover connection portion 55 of the body.

When the mask is worn, the body 50 is bent into a curved surface in accordance with a facial contour of the wearer. In this case, when the body 50, more particularly, the cover connection portion 55 of the body 50, is formed while forming line-bonding with the cover 100, it is difficult to comfortably fold the body 50 and the cover 100. That is, when the cover 100 is raised or lowered, the entire cover connection portion 55 of the body that is a foldable portion in which the cover 100 and the body 50 are connected to each other is coupled in line bonding, and a smooth folding operation is not performed.

Thus, in the present invention, the cover 100 and the cover connection portion 55 of the body 50 are bonded not by the line-bonding but by point-bonding, so that the cover 100 may be easily folded.

To this end, in the present invention, a through-hole 120 is formed at a portion of the cover 100 to induce the line-bonding to be close to the point-bonding. When the mask 10 of the present invention is viewed from the front side, the through-hole 120 is located above the cover 100. In the embodiment of the present invention, when an approximate shape of the through-hole is viewed as a reference when the cover closes the opening, the through-hole is illustrated as a shape similar to a semicircle as a whole in which a lower portion has a circular arc shape and an upper portion has a linear shape, but the shape of the through-hole is not limited thereto.

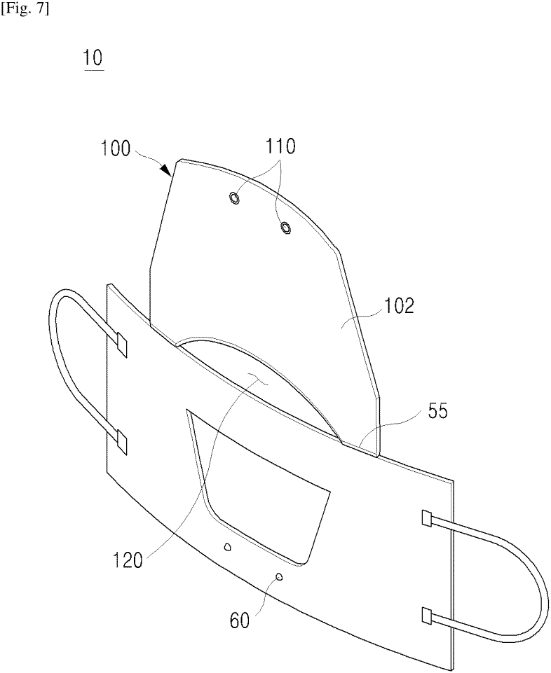

In the present invention, the remaining portion of the cover 100 in which the through-hole 120 is not formed and the body 50 are integrally connected to each other, and thus the cover connection portion 55 of the body 50 is formed. That is, as illustrated in FIG. 7, the cover 100 and the body 50 are almost point-bonded at two points.

When the wearer raises the cover 100 by the through-hole 120, the cover 100 is naturally folded without interfering with the body 50, and thus the opening 70 of the body 50 may be exposed. In contrast, even when the cover 100 is lowered, the cover 100 is naturally folded without interfering with the body 50, and thus the opening 70 may be closed.

As described above, in the embodiment of the present invention, the body 50 and the cover 100 are made of a transparent resin (plastic) material.

When the body 50 and the cover 100 are formed in a flat surface and the wearer wears the mask 10, the body 50 forms a curved shape by a tensile force of the hanging string 20 hung on the ear and is in close contact with the face. Alternatively, from the beginning, the body 50 and the cover 100 may be formed in a curved surface.

The body 50 and the cover 100 of the present invention are fixed by a configuration which will be described below.

The openable mask 10 of the present invention is formed with a coupling boss 60 and a coupling hole 110 for fixing the body 50 and the cover 100. That is, the coupling boss 60 of the body is formed to protrude below a front surface 51 of the body 50. The coupling hole 110 is formed in a rear surface 102 of the cover to face a location at which the coupling boss 60 of the body is formed. The wearer inserts or separates the coupling protrusion 60 into or from the coupling hole 110 as needed, and may freely fix or unfix the cover 100.

The openable mask 10 of the present invention may be formed with a female or male Velcro tape for fixing the body 50 and the cover 100. That is, a female Velcro tape 60′ may be formed at a lower portion of the front surface 51 of the body 50. A male Velcro tape 110′ is formed on the rear surface 102 of the cover to face a location at which the female Velcro tape 60′ of the body is formed. Of course, the male and female Velcro tapes may be provided to be reversed.

The coupling boss 60, the coupling hole 110, and the male and female Velcro tapes 60′ and 110′ may be replaced with a configuration such as magnet or a snap fastener.

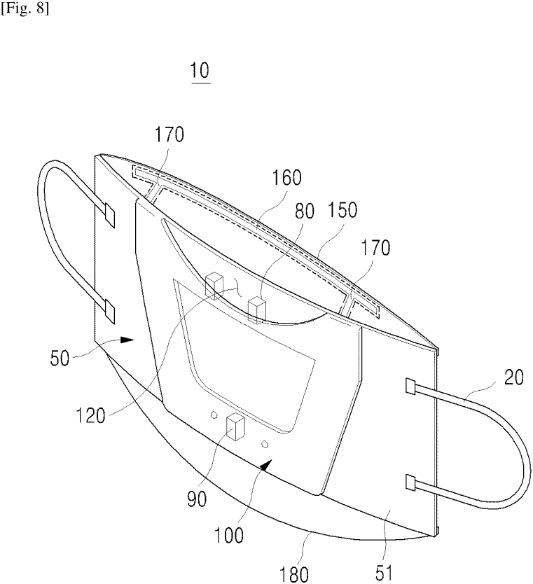

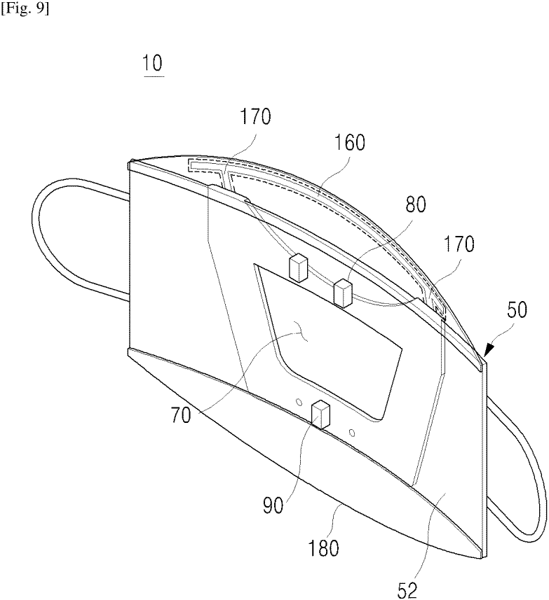

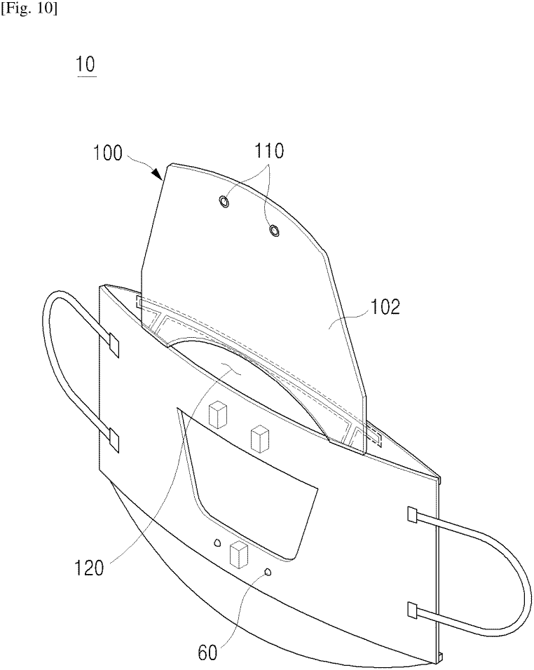

FIGS. 8 to 10 illustrate an openable mask 10 according to another embodiment of the present invention.

In the openable mask 10 of the present invention, a nose support portion 80 is formed to protrude upward from the rear surface 52 of the body, and a chin support portion 90 is formed to protrude downward from the rear surface 52 of the body. In the present invention, since the body 50 is made of a transparent resin material, when the face of the wearer sweats, discomfort such as close contact between the body 50 and the face may be caused. Thus, as the nose support portion 80 and the chin support portion 90 are formed at an upper portion of the rear surface 52 of the body and a lower portion of the rear surface 52 of the body, respectively, the face of the wearer and the body 50 are spaced a predetermined distance from each other, and thus excessive contact between the body 50 and the face is prevented.

In the openable mask 10 of the present invention, an upper nonwoven fabric 150 and a lower nonwoven fabric 180 may be additionally coupled to the rear surface 52 of the body. This nonwoven fabric is a material constituting a general disposable mask. The upper nonwoven fabric 150 is located above the nose support portion 80, and the lower nonwoven fabric 180 is located below the chin support portion 90. The upper nonwoven fabric 150 and the lower nonwoven fabric 180 are coupled to the rear surface 52 of the body by a method such as thermal bonding.

A core material 160 is inserted into a face-side end of the upper nonwoven fabric 150 in a lengthwise direction so that a degree of close contact of the upper nonwoven fabric 150 may be adjusted according to the facial contour of the wearer.

Further, the upper nonwoven fabric 150 is provided with a vertical core material 170 in a direction perpendicular to the core material 160, the body 50 and the facial skin of the wearer are spaced a predetermined distance from each other, and thus the rear surface of the body 50 can be prevented from excessively coming into contact with or being pressed against the face of the wearer by pulling the body 50 through the hanging string 20 from an ear side.

In the openable mask 10 of the present invention, the opening 70, the cover 10, and the through-hole 120 can be simultaneously formed through a method such as punching a transparent fabric. Thus, a manufacturing method is simple, and efficient production can be achieved.

As described above, an optimum embodiment is disclosed in the drawings and the specification.

Although specific terms are used herein, the terms are used only for describing the present invention and are not used to limit the meaning or the scope of the present invention described in the appended claims. Therefore, those skilled in the art should understand from this that various modifications and other equivalent embodiments are possible. Thus, the true technical scope of the present invention should be determined by the technical spirit of the appended claims.

Description of Reference Numerals

| | | | |
|---|---|---|---|
| 10: | Openable mask | 20: | Hanging string |
| 50: | Body | 51: | Front surface of body |
| 52: | Rear surface of body | 55: | Cover connection portion of body |
| 60: | Coupling boss | 70: | Opening |
| 80: | Nose support portion | 90: | Chin support portion |
| 100: | Cover | 101: | Front surface of cover |
| 102: | Rear surface of cover | 110: | Coupling hole |
| 120: | Through-hole | 150: | Upper nonwoven fabric |
| 160: | Core material | 170: | Vertical core material |
| 180: | Lower nonwoven fabric | | |

1. An openable mask comprising:
a body having an opening through which a mouth of a wearer is exposed and a hanging string on an outer side thereof; and
a cover folded to open or close the opening of the body according to the wearer’s selection,
wherein the body and the cover are integrally formed and are then formed to be folded with respect to each other at a foldable portion,
a through-hole is provided above the cover along the foldable portion, and
the body and the cover are made of a transparent resin material.

2. The openable mask of claim 1, further comprising:
a coupling boss of the body protruding from a lower portion of a front surface of the body; and
a coupling hole formed in the cover to face a location at which the coupling boss is formed.

3. The openable mask of claim 1, further comprising:
a female or male Velcro tape formed on a lower portion of a front surface of the body; and
a male or female Velcro tape formed on a rear surface of the cover formed to face a location at which the female or male Velcro tape is formed.

4. The openable mask of claim 1, further comprising:
a nose support portion protruding from an upper portion of a rear surface of the body; and
a chin support portion protruding from a lower portion of the rear surface of the body.

5. The openable mask of claim 1, further comprising:
an upper nonwoven fabric and a lower nonwoven fabric coupled to a rear surface of the body,
wherein a face-side end of the upper nonwoven fabric is provided with a core material, which adjusts an end of the upper nonwoven fabric to be in contact with a facial contour, in a lengthwise direction of the nonwoven fabric.

6. The openable mask of claim 5, wherein the upper nonwoven fabric coupled to the rear surface of the body is additionally provided with a vertical core material which spaces the body and the wearer’s face apart from each other by a predetermined distance and is perpendicular to the core material.
